(19) United States
(12) Patent Application Publication
(10) Pub. No.: US 2025/0339341 A1
(43) Pub. Date: Nov. 6, 2025

(54) LABELING SHELL FOR A DRUG VIAL

(71) Applicant: Merck Sharp & Dohme LLC, Rahway, NJ (US)

(72) Inventors: Eduardo Cristofolli, Elizabeth, NJ (US); John B. Cline, Monroe, NJ (US); Wail Rasheed, Union, NJ (US); Raymond K. Seto, Warren, NJ (US); Steven Carl Persak, Morris Plains, NJ (US); Tinh Nguyen-Demary, Milltown, NJ (US)

(73) Assignee: Merck Sharp & Dohme LLC, Rahway, NJ (US)

(21) Appl. No.: 19/268,323

(22) Filed: Jul. 14, 2025

Related U.S. Application Data
(62) Division of application No. 17/775,480, filed on May 9, 2022.
(60) Provisional application No. 62/935,686, filed on Nov. 15, 2019.

(51) Int. Cl. A61J 1/18; A61J 1/06; A61J 1/14

(52) U.S. Cl. CPC A61J 1/18; A61J 1/065; A61J 1/1412

(57) ABSTRACT

In one aspect of the subject invention, a labeling shell is provided for a drug vial having a glass reservoir and an opening sealed by an elastomeric stopper, the labeling shell including: a polymeric tubular body formed to accommodate the reservoir of the drug vial, the tubular body having a first open end defining a first opening smaller than a diameter of the reservoir of the drug vial so as to prevent passage therethrough of the reservoir, wherein the elastomeric stopper is exposed through the first end with the reservoir being accommodated in the tubular body; and, a polymeric cap removably mountable to the tubular body to selectively cover the elastomeric stopper of the drug vial with the reservoir being accommodated in the tubular body. Advantageously, the subject invention provides a labeling surface for a drug vial, while also providing restricted access to the drug vial to limit tampering therewith.

### CROSS-REFERENCE TO RELATED APPLICATIONS

This application is a divisional Application of U.S. patent application Ser. No. 17/775,480, filed May 9, 2022, which is a National Stage application of International Patent Application No. PCT/US2020/059767, filed Nov. 10, 2020, which claims the benefit of priority to U.S. Provisional Patent Application No. 62/935,686, filed Nov. 15, 2019, the contents of each of which are hereby incorporated by reference in their entireties

### FIELD OF THE INVENTION

The subject invention relates to packaging for drug vials, and, more particularly, to labeling shells for drug vials.

### BACKGROUND OF THE INVENTION

Drug vials are well known in the prior art for storing liquid drugs and vaccines, particularly for injection. Drug vials may have a glass reservoir with an opening sealed by an elastomeric stopper. Drug contained in the reservoir is accessed by a needle piercing the elastomeric stopper with subsequent aspiration, typically with use of a syringe. The elastomeric stopper is typically self-sealing to allow multiple piercings if necessary. The elastomeric stopper may be held on the reservoir through use of a ferrule, typically metallic, secured to a portion of the reservoir, such as a reduced-diameter neck.

Drug vials are individually labeled and packaged based on drug specifications. Issues may arise with adhesion of labels, particularly at cryogenic temperatures. During clinical trials, drug vials may be utilized and exposed to various conditions. For example, many vaccines are stored at temperatures as low as −70° C. Ensuring proper labeling is important in all drug storage and administering environments, particularly where critical cold storage temperatures are required.

When vials containing drugs or vaccines at cryogenic temperatures are temporarily removed from cold storage for labeling, condensation will form on the surface of the vials.

This condensation can compromise the bond between the drug vial and any pressure-sensitive-adhesive label applied to the drug vial. Furthermore, removing the drug vial temporarily from cold storage for label application may result in an undesirably long time out of refrigeration, which could potentially affect the viability of the drug vial contents if the temperature thereof exceeds specified limits. It is desirable to have a labeling method that minimizes the time a vial is out of cold storage.

Furthermore, handling cryogenic stored vials with protective gloves is awkward and carries potential risks of mishandling the vials. It is desirable to have a method of packaging the vials that improves ease of handling.

In addition, direct handling of drug vials carries potential risk of impact damage to the vials stored at cryogenic temperatures. It is desirable to have a method of packaging the vials that minimizes the potential for impact damage.

### SUMMARY OF THE INVENTION

Provided in one aspect of the subject invention is a labeling shell for a drug vial having a glass reservoir and an opening sealed by an elastomeric stopper, the reservoir having a barrel portion, the labeling shell comprising:
a polymeric tubular body formed to accommodate the reservoir of the drug vial, the tubular body having a first open end defining a first opening having a first diameter smaller than a diameter of the barrel portion of the reservoir of the drug vial so as to prevent passage therethrough of the reservoir, wherein the elastomeric stopper is exposed through the first open end with the reservoir being accommodated in the tubular body; and,
a polymeric cap removably mountable to the tubular body to selectively cover the elastomeric stopper of the drug vial with the reservoir being accommodated in the tubular body.

In an embodiment of the invention, the tubular body includes a second open end, axially spaced from the first open end. In a class of the embodiment, the second open end defines a second opening having a second diameter larger than a diameter of the barrel portion of the reservoir of the drug vial so as to allow passage therethrough of the reservoir.

In an embodiment of the invention, the tubular body further comprises a closure formed to at least partially cover the second open end.

In embodiment of the invention, the second open end defines a second opening, the closure being formed to be received in the second opening.

In an embodiment of the invention, the tubular body of the labelling shell is clamshell configured with a first tubular body portion hingedly connected to a second tubular body portion. In a class of the embodiment, cooperating locking members are provided on the first and second tubular body portions configured to lock together the first and second tubular body portions in the form of the tubular body.

In an embodiment of the invention, the cap is connected by a tether to the tubular body.

In an embodiment of the invention, at least one window is formed in the tubular body to permit viewing of the reservoir with the reservoir being accommodated in the tubular body. Provided in another aspect of the instant invention, is a labeling shell for a drug vial having a glass reservoir and an opening sealed by an elastomeric stopper, the shell comprising:
a polymeric cup-shaped body formed to accommodate the drug vial, the body having a base and an upstanding side wall perimetrically bounding the base; and,
a polymeric cap mountable to the tubular body, the cap defining an opening having a diameter configured to allow access to the elastomeric stopper of the drug vial therethrough with the reservoir being accommodated in the body.

In an embodiment of the invention, the labelling shell further comprises a compartment located on an exterior of the body.

In an embodiment of the invention, a plurality of upstanding retainer fingers is provided on the base interiorly of the side wall of the labelling shell, the retainer fingers being positioned to receive therein the reservoir of the drug vial. In a class of the embodiment, the retainer fingers are positioned to align the elastomeric stopper of the drug vial with the opening of the cap with the reservoir being accommodated in the body.

In an embodiment of the invention, the opening is configured to prevent passage therethrough of the drug vial.

Provided in another aspect of the instant invention, is a labeling shell for a drug vial having a glass reservoir and an opening sealed by an elastomeric stopper, the reservoir having a barrel portion. the shell comprising:
a base having a plurality of upstanding retainer fingers each having an inwardly-projecting rib, wherein the ribs collectively define a locus of points defining a first diameter smaller than the barrel portion of the reservoir, wherein a second diameter, larger than the first diameter, is defined below the ribs, between the retainer fingers, formed to accommodate the barrel portion of the reservoir, wherein, the retainer fingers are inherently biased inwardly; and,
a side wall securable to the base to circumscribe the retainer fingers.

In an embodiment of the invention, the labeling shell further comprises a covering cap formed to be removably mounted relative to the side wall.

In an embodiment of the invention, a bead is formed on the covering cap formed to releasably interengage one or more channels formed on the retaining fingers.

Provided in another aspect of the instant invention, is a labeling shell for a drug vial having a glass reservoir and an opening sealed by an elastomeric stopper, the reservoir having a barrel portion, the shell comprising:
a base having a plurality of upstanding retainer fingers, each finger having an inwardly-projecting rib at its tip, wherein the ribs collectively define a locus of points defining a first diameter smaller than the barrel portion of the reservoir, wherein each finger has an outward facing channel, wherein each channel is formed to accommodate a mounting lip of a covering cap, a tubular side wall with a first opening and a second opening, and a covering cap, wherein the base attaches to the side wall at its first opening and the side wall attaches to the covering cap at its second opening.

In an embodiment of the invention, tubular side wall fits over the base whereby the upstanding retaining fingers of the base are restrained from outward movement by the side wall that is attached to the base.

In an embodiment of the invention, tubular side wall comprises a plurality of inward facing locking ribs at its first opening, wherein said locking ribs engage with a circumferential locking channel in the base.

In an embodiment of the invention, wherein the upstanding retaining fingers are prevented from significant inward movement by the drug vial and are prevented from significant outward movement by the tubular side wall.

In an embodiment of the invention, wherein the outward facing channels of the upstanding retaining fingers of the base engage with a circumferential bead on the covering cap.

These and other features of the subject invention will be better understood through a study of the following detailed description and accompanying drawings.

### BRIEF DESCRIPTION OF THE DRAWINGS

FIGS. 1-10 show a first embodiment of a labeling shell formed in accordance with the subject invention;

FIGS. 11-13 show a second embodiment of a labeling shell formed in accordance with the subject invention; and,

FIGS. 14-18 show a third embodiment of a labeling shell formed in accordance with the subject invention.

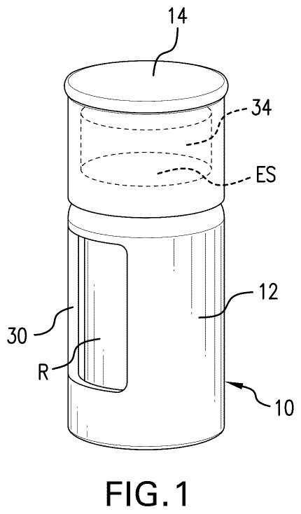

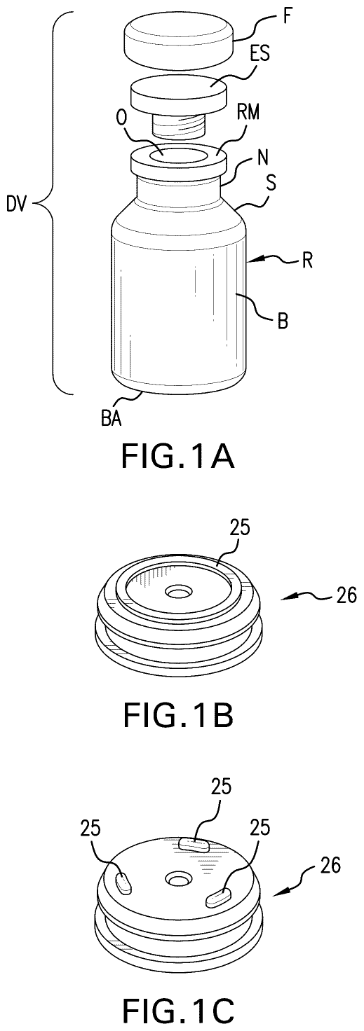

FIG. 1 shows a labelling shell including a tubular body and a cap.

FIG. 1A shows an exploded view of a vial with a stopper and crimp cap.

FIG. 1B shows a closure of a labelling shell having a circumferential rib.

FIG. 1C shows a closure of a labelling shell having discrete bumps.

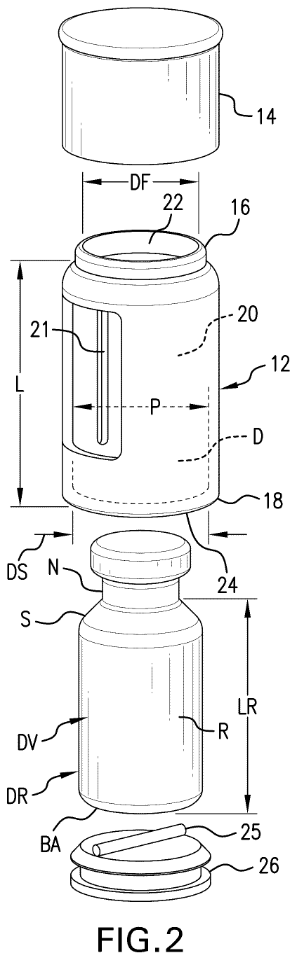

FIG. 2 shows a shows an exploded view of a vial and a labelling shell.

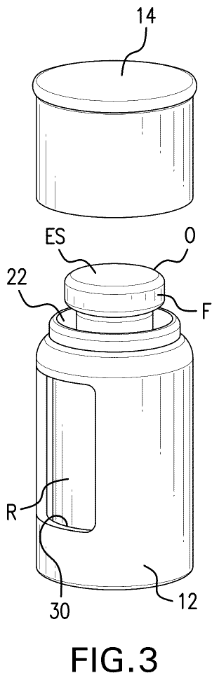

FIG. 3 shows a vial and a labelling shell where the elastomeric stopper is located externally of the opening of the shell.

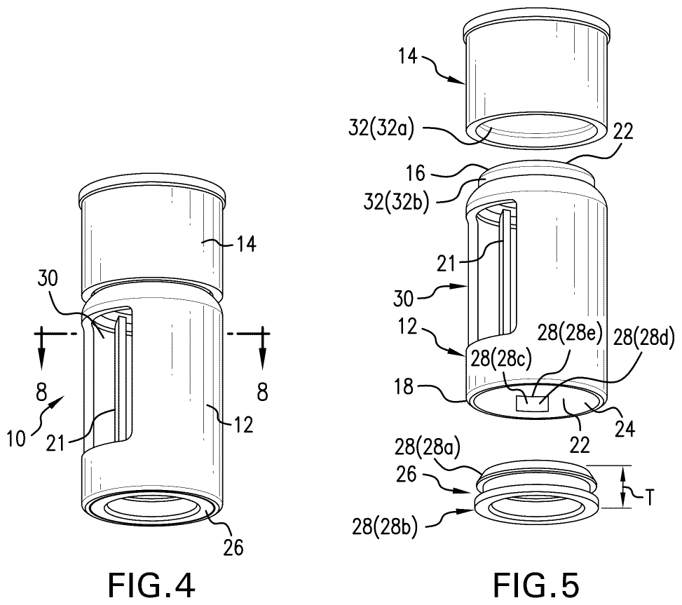

FIG. 4 shows a labelling shell with a window within the tubular body which permits viewing of the reservoir.

FIG. 5 shows a labelling shell wherein the closure has spaced-apart ribs.

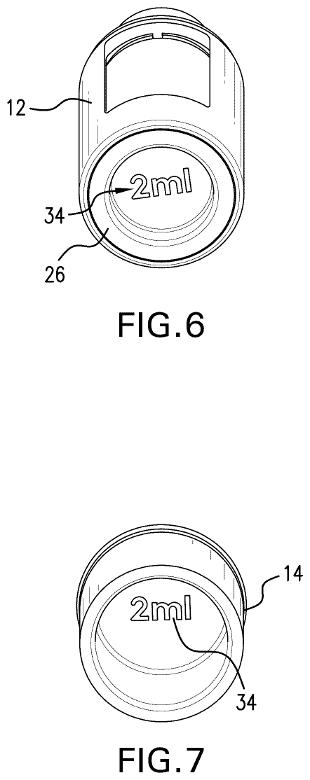

FIG. 6 shows representative indicia to indicate the size of the drug vial to be used with the labelling shell.

FIG. 7 shows representative indicia to indicate the size of the drug vial to be used with the labelling shell.

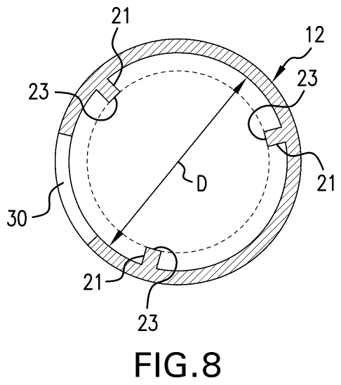

FIG. 8 shows a plurality of ribs provided on the tubular body which extend into the lumen of the labelling shell.

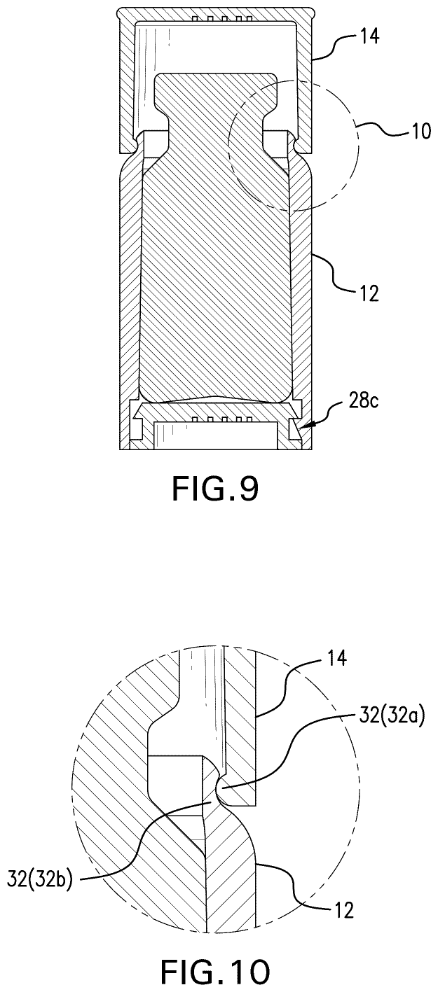

FIG. 9 shows a cap having a mounting lip to snap engage with a mounting channel on the tubular body of the labelling shell.

FIG. 10 shows a larger view of a cap having a mounting lip to snap engage with a mounting channel on the tubular body of the labelling shell.

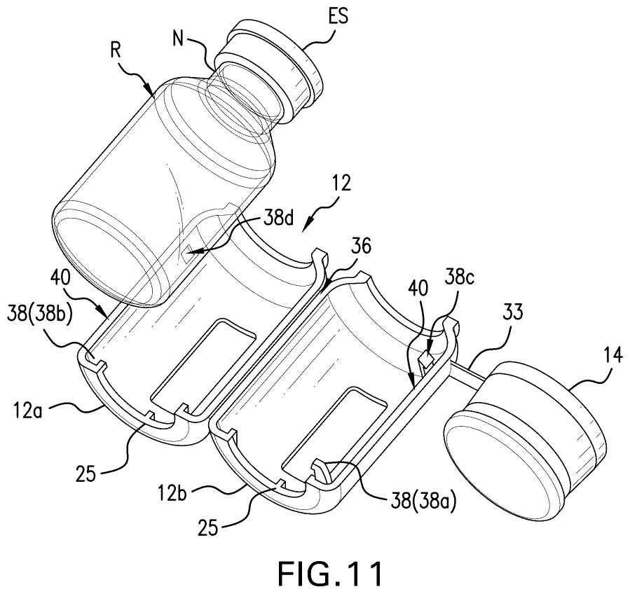

FIG. 11 shows a labelling shell, which is clamshell configured. The labelling shell is shown before the vial is inserted and the shell is closed.

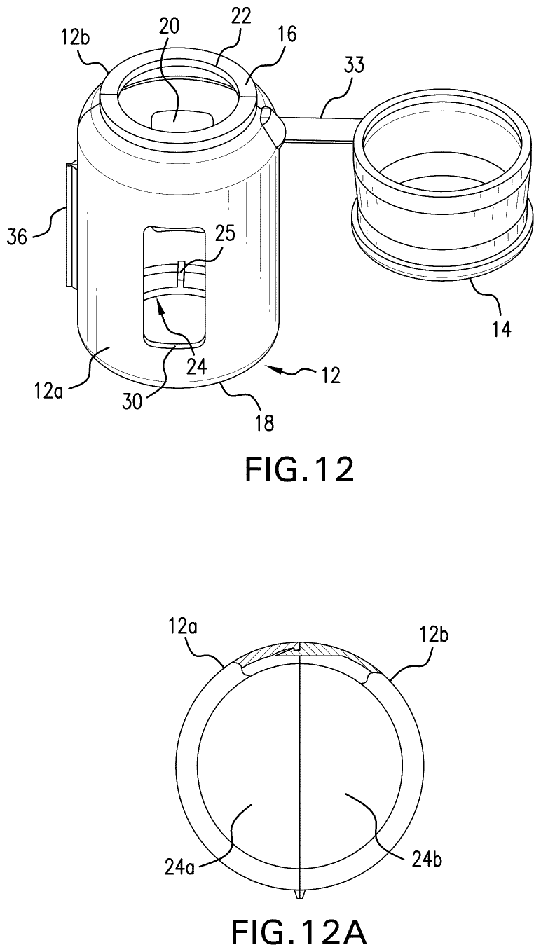

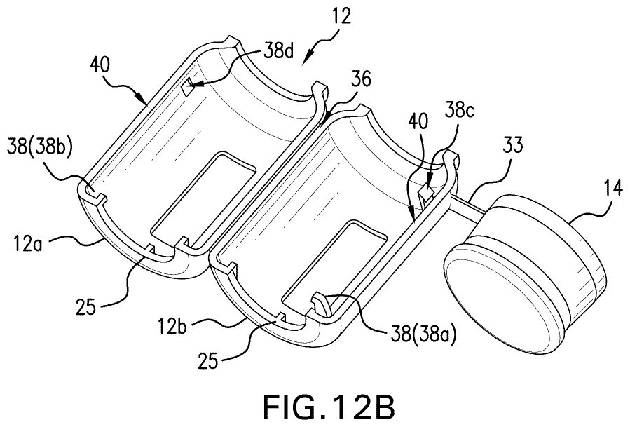

FIG. 12 shows a labelling shell, which is clamshell configured, when it is closed and without a vial inside of it.

FIG. 12A shows the two sections of the clamshell configured labelling shell locking together.

FIG. 12B shows a labelling shell, which is clamshell configured, when it is open and without a vial inside of it.

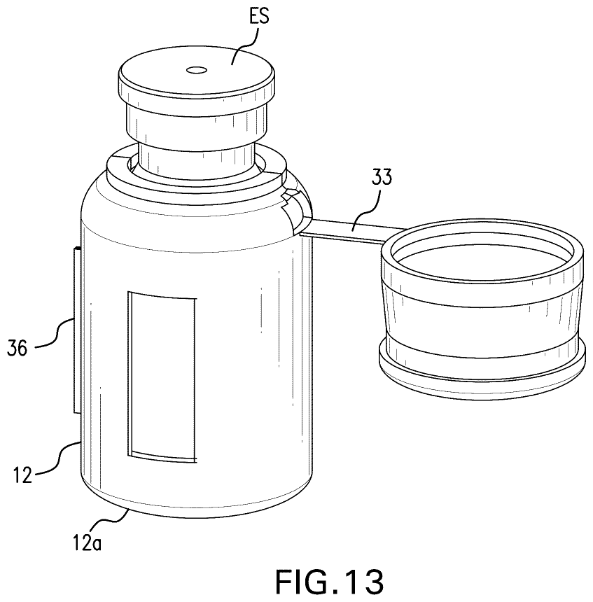

FIG. 13 shows a labelling shell, which is clamshell configured, when it is closed and with a vial inside of it.

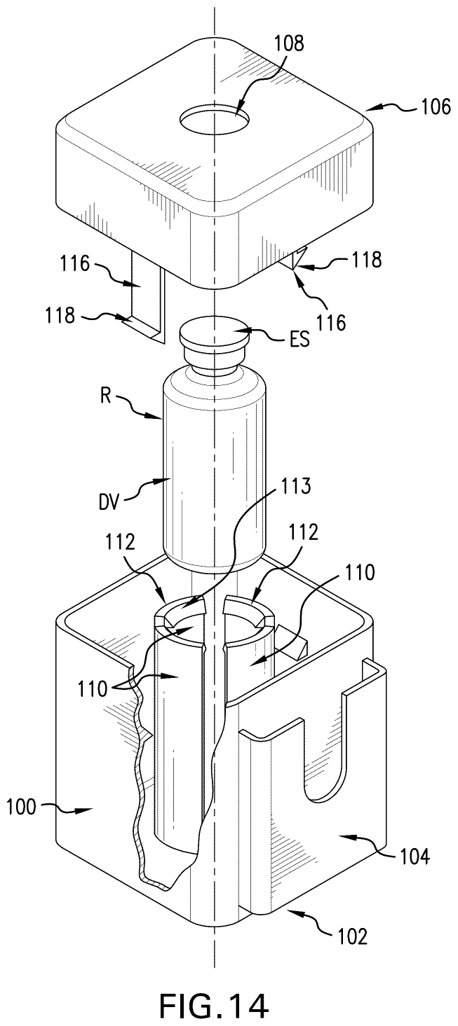

FIG. 14 shows an exploded view of labeling shell having a cup-shaped body and a vial therein.

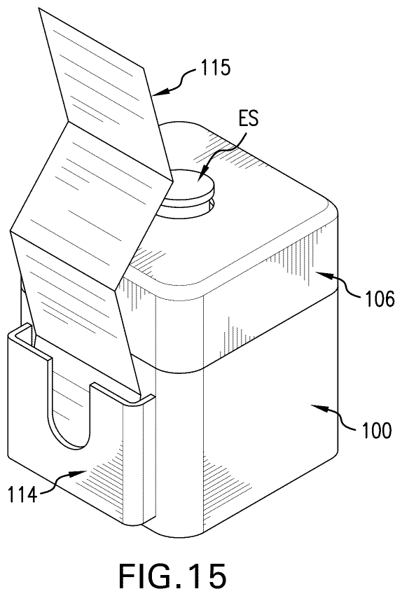

FIG. 15 shows a labelling shell having a cup-shaped body wherein the neck of the vial extends through the cap opening.

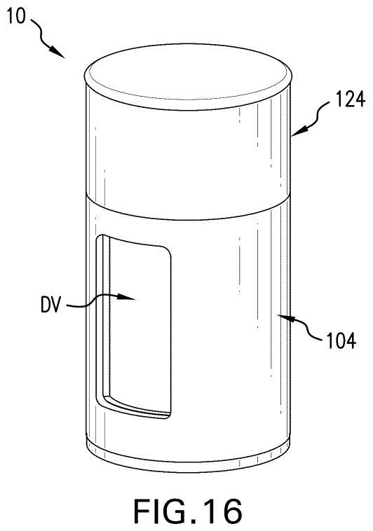

FIG. 16 shows a labelling shell wherein no closure is provided.

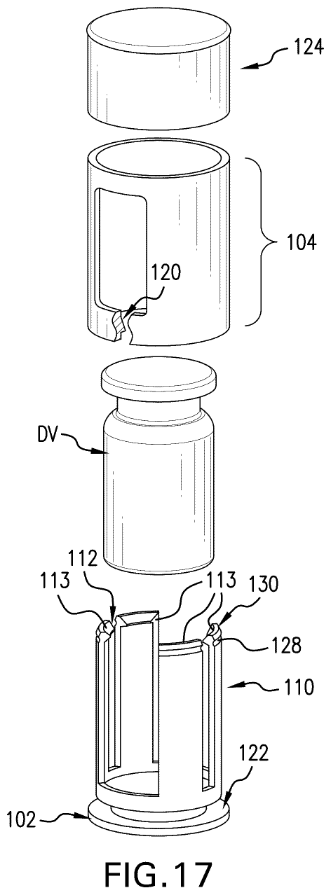

FIG. 17 shows an exploded view of a labelling shell comprising a covering cap.

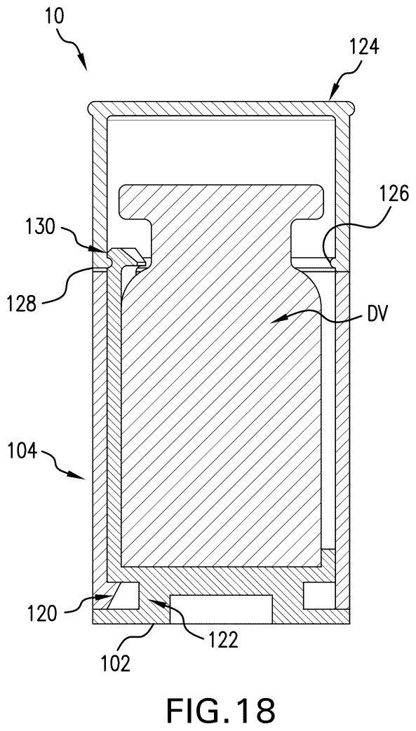

FIG. 18 shows a labelling shell with a covering cap.

### DETAILED DESCRIPTION OF THE INVENTION

Various embodiments of a labeling shell for a drug vial having a glass reservoir are described herein and depicted in the accompanying drawings. The labeling shell is formed to accommodate the glass reservoir therein to provide a separate, external, polymeric labeling surface. The labeling shell may also include a cap to restrict access to the drug vial, also providing for tamper-proofing. As will be understood by those skilled in the art, drug vials may vary in size. The labeling shell of the subject invention will be configured to the size and configuration of the intended-use drug vials, consistent with the description below.

With reference to FIG. 1A, the subject invention is for use with any drug vial DV configuration having a reservoir R, which may be a container-shaped body for accommodating one or more drugs (e.g., one or more therapeutically or biologically active agents in solid or liquid form). The reservoir R may be composed of glass or a polymeric material. The reservoir R includes an opening O which is sealed by elastomeric stopper ES. The elastomeric stopper ES may be maintained in the opening O by a crimp cap F located about thereabout.

Further, the reservoir R may have a barrel portion B extending from a base BA to a reduced diameter shoulder S. The barrel portion B may have a relatively constant cross-section along the full length thereof. The reservoir R may further include a neck N extending from the shoulder S to define the opening O. A rim RM may be formed on the neck N about the opening O to which the crimp cap F may be fixed.

With reference to FIGS. 1-10, a first embodiment of a labeling shell is provided and generally designated with the reference numeral 10. The labeling shell 10 generally includes a tubular body 12 and a cap 14. The tubular body 12 is generally cylindrical and formed to accommodate the reservoir R of the drug vial DV. In particular, the tubular body 12 is elongated with opposing first and second ends 16, 18 with an open lumen 20 extending therebetween. The diameter D of the lumen 20 is preferably larger than the diameter DR of the barrel portion B of the reservoir R. The diameter D is more preferably slightly larger than the diameter DR of the reservoir R, e.g., the diameter D generally ranging from being 0 mm to 3 mm larger than the diameter, depending on the diameter DR. This allows for clearance between the reservoir R and the tubular body 12 with the reservoir R being accommodated in the lumen 20, while preventing excessive movement of the reservoir R within the tubular body 12. In addition, the length L between the first and second ends 16, 18 is preferably equal to or larger than the length LR between the base BA and the shoulder S of the reservoir R. The length L is more preferably slightly larger than the length LR of the reservoir R, e.g., the length L generally ranging from being 0 mm to 3 mm larger than the length LR. In this manner, the tubular body 12 is at least coextensive with the barrel portion B of the reservoir R with the reservoir R accommodated in the lumen 20.

With reference to FIG. 8, a plurality of ribs 21 may be provided on the tubular body 12 extending into the lumen 20. The ribs 21 may be evenly spaced about the lumen 20. The ribs 21 may collectively define the diameter D, particularly at free ends 23 thereof. This allows for minimal contact between the reservoir R and the tubular body 12, while minimizing the ability of the reservoir R to move within the tubular body 12.

A first opening 22 is formed in the first end 16. The first opening 22 defines a diameter DF which is smaller than the diameter D of the lumen 20. The diameter DF is also smaller than the diameter DR, thereby preventing passage therethrough of the reservoir R. This arrangement restricts removal of the drug vial DV from the tubular body 12 through the first end 16. The diameter DF may be sized to be larger than the neck N but smaller than the diameter DR. This arrangement also restricts removal of the drug vial DV from the tubular body 12 through the first end 16.

To allow for placement of the reservoir R into the lumen 20, the second end 18 is preferably open defining a second opening 24 having a diameter DS larger than the diameter DR of the reservoir R. Preferably, the diameter DS of the second opening 24 is equal to the diameter D of the lumen 20. To load the drug vial DV into the tubular body 12, the drug vial DV is inserted into the lumen 20 with elastomeric stopper ES leading. The elastomeric stopper ES provides access to any contents contained in the reservoir R. The elastomeric stopper ES may be pierced by a needle to access the contents, particularly by the needle of a syringe having a plunger to aspirate liquid drug from the reservoir R or to inject a diluent into the reservoir R to reconstitute a solid drug contained therein.

As shown in FIG. 3, the elastomeric stopper ES may be exposed with the reservoir R accommodated in the tubular body 12. The elastomeric stopper ES may be located externally of the first opening 22, so as to be outside the tubular body 12. This can be achieved with the neck N having sufficient length to extend through, and beyond, the first opening 22. Alternatively, it is possible for the elastomeric stopper ES to be located interiorly of the first opening 22 such that the entire drug vial DV is fully contained within the tubular body 12.

A closure 26 may be provided to at least partially cover the second end 18, more particularly, to at least partially cover the second opening 24. The closure 26 may be disc-shaped configured to be received in, and fully cover, the second opening 24. The tubular body 12 and the closure 26 may be formed with cooperating locking elements 28 to lockingly retain the closure 26 to the second end 18. For example, as shown in FIG. 5, the closure 26 may be provided with spaced-apart ribs 28a, 28b with the tubular body 12 being provided with at least one protrusion 28c formed to seat between the ribs 28a, 28b with the closure 26 being forced into the second opening 24. The protrusion 28c may be saw-tooth shaped having a downward facing ramped surface 28d, to facilitate by-passing of a leading rib 28a, and a flat stop surface 28e extending radially from the ramped surface 28, transverse to the longitudinal axis of the lumen 20, to restrict removal of the closure 26 (the stop surface 28e acting to inhibit movement of at least the initial rib 28a out of the lumen 20). As will be appreciated by those skilled in the art, various retention techniques may be used to retain the closure 26 on the second end 18, including, but not limited to, fusion, welding, adhesion, cooperating threads, cooperating bayonet-lock type members, cooperating snap-engagement features (e.g., coopering ribs and grooves, protrusions and depressions, etc.), and the like. It is also possible to provide the closure 26 to be removably mountable to the tubular body 12. The closure 26 is formed with sufficient thickness T to permit a robust connection with the tubular body 12. The thickness T also discourages physical tampering with the closure 26 once it has been attached to the body 12.

The length L of the tubular body 12 and the location of the attachment of the closure 26 may be selected to limit axial clearance between the tubular body 12 and the drug vial DV. One or more base ribs 25 (FIGS. 1B, 1C, 2) may be provided on the closure 26 to provide limited line contact with the reservoir R, thereby avoiding face-to-face area contact between the closure 26 and the reservoir R. The base ribs 25 may be of any configuration, including defining a closed shape (such as a circle) and/or of discrete lengths in various patterns (linear, circular, etc.). The interface between the first opening 22 and the reservoir R, for example, along the shoulder S, may also contribute to limiting axial movement of the reservoir R within the tubular body 12. In all, limited radial and axial clearance between the drug vial DV and the tubular body 12 limits movement of the drug vial DV within the tubular body 12. It is preferred that the drug vial DV not be immovably maintained (e.g., by interference fit) within the tubular body 12, with some limited movement being permitted, to accommodate differential expansion or shrinkage between drug vial DV and the tubular body 12.

One or more windows 30 may be formed in the tubular body 12 which permits viewing of the reservoir R, while accommodated in the tubular body 12, from an external vantage point. This allows a user to visually inspect the contents of the reservoir R. Preferably, the window 30 is elongated aligned to extend between the first and second ends 16, 18, thereby allowing visual inspection along a length of the reservoir R.

The cap 14 is generally cup-shaped and formed to selectively cover the elastomeric stopper ES with the reservoir R being accommodated in the tubular body 12. The cap 14 and the tubular body 12 may include cooperative retention features 32 which allow for removable mounting of the cap 14 to the tubular body 12. By way of non-limiting example, as shown in FIGS. 9-10. the cap 14 may include mounting lip 32a formed to snap engage with mounting channel 32b formed on the tubular body 12, such as about the first opening 22. Alternatively, the cooperative retention features 32 may be in the form of cooperating threads. The cap 14 is preferably formed with sufficient length to define a head space 34 above the elastomeric stopper ES with the cap 14 mounted to the tubular body. This avoids contact between the cap 14 and the elastomeric stopper ES during transportation and storage. It is noted that the elastomeric stopper ES should be sterilized prior to use, such as being wiped with an anti-septic wipe or equivalent. The subject invention provides easy access to the elastomeric stopper ES for such purpose. Optionally, a tether 33 (FIG. 12) may be provided to connect the cap 14 to the tubular body 12.

The tubular body 12 and the cap 14 are preferably formed of a polymeric material. This allows for formation by injection molding. The polymeric material may be selected from one or more of: polypropylene (PP), high density polyethylene (HDPE), low density polyethylene (LDPE), thermoplastic elastomer, acrylonitrile butadiene styrene (ABS), polyester, and nylon. In preferred embodiments, additives may be incorporated in the polymeric material to improve its resilience at cryogenic temperatures. Additives may be also employed to improve the affinity of the polymeric material to pressure sensitive label adhesive.

With reference to FIGS. 6 and 7, indicia 34 may be provided on any of the tubular body 12, the cap 14, and/or the closure 26 to indicate the size of the drug vial DV to be used with the labeling shell 10. The indicia 34 may be molded into the respective component(s), or formed otherwise, such as by etching, milling, embossing, etc. The indicia 34 may be also provided as printed material which is applied to the respective components, e.g., with adhesive, such as through the use of adhesive-backed stickers.

With reference to FIGS. 11-13, in a second embodiment, the tubular body 12 may be clamshell configured with a first body portion 12a connected by a hinge 36 to a second body portion 12b. The hinge 36 is preferably a living hinge formed unitarily with the first and second body portions 12a, 12b, but may be provided as a separate, attachable component. The first and second body portions 12a, 12b may be each formed as half a barrel so that collectively the first and second body portions 12a, 12b define the tubular body 12 when assembled.

With respect to the first embodiment, the drug vial DV may be loaded into the tubular body 12 through the second opening 24. Thus, the second opening 24 must be sufficiently sized to accommodate passage therethrough of the reservoir R. With the second embodiment, as shown in FIG. 11, the drug vial DV may be introduced in between the first and second body portions 12a, 12b with the first and second body portions 12a, 12b being rotated about the hinge 36 to encase the reservoir R. In this arrangement, the second opening 24 may be formed smaller than the barrel portion B of the reservoir R to prevent passage thereof through the second end 18. The second opening 24 may be eliminated by forming the second end 18 solid, defined by adjoining portions 24a, 24b (FIG. 12a) of the first and second body portions 12a, 12b. Depending on the configuration of the second end 18, the closure 26 may not be required with the second embodiment.

It is preferred that cooperating locking members 38 be provided on the first and second body portions 12a, 12b configured to lock together the first and second tubular body portions 12a, 12b in the form of the tubular body 12. For example, the locking members 38 may be formed along free edges 40 of the first and second body portions 12a, 12b configured and positioned to lock together with the assembly of the first and second body portions 12a, 12b. With the hinge 36 along one set of edges of the first and second body portions 12a, 12b, and the locking members 38 being located along the free edges 40, the tubular body 12 may be maintained in a locked, assembled state with the reservoir R accommodated therein. The locking members 38 may be a barb 38a formed for irreversible insertion into channel 38b. As will be appreciated by those skilled in the art, various locking combinations may be utilized.

Other than features aforementioned, the description of the first embodiment and related reference numbers apply equally to the second embodiment.

With reference to FIGS. 14-15, a third embodiment of the labeling shell 10 is provided. Here, a cup-shaped body 100 is provided formed to accommodate the drug vial DV. The body 100 includes a base 102 with an upstanding side wall 104 perimetrically bounding the base 102. A cap 106 is provided configured to mount to the body 100, preferably the cap 106 being irreversibly mounted to the body 100. The cap 106 defines a cap opening 108 having a diameter DC configured to allow access to the elastomeric stopper ES of the drug vial DV therethrough with the reservoir R being accommodated in the body 100. In addition, the diameter DC may be configured to prevent passage therethrough of the drug vial DV.

A plurality of retaining fingers 110 may be provided on the base 102 interiorly of the side wall 104, the retainer fingers 110 being positioned to receive therein the reservoir R of the drug vial. The retainer fingers 110 may be resiliently cantilevered to the base 102 to permit outward flexing with introduction of the reservoir R therebetween. The retainer fingers 110 may be inherently biased towards a center of the base 102. This allows for the retainer fingers 110 to graspingly receive the reservoir R. Distal ends 112 of the retainer fingers 110 may include inwardly-projecting ribs 113 to collectively restrict removal of the reservoir from between the retainer fingers 110. The ribs 113 may define a locus of points defining a diameter smaller than the barrel portion B of the reservoir R. A diameter is defined below the ribs 113, between the retainer fingers 110, sized to accommodate the barrel portion B of the reservoir R. The smaller diameter defined by the ribs 113 restricts passage of the barrel portion B therethrough. The retainer fingers 110 are positioned to align the elastomeric stopper ES with the cap opening 108 with the reservoir R being accommodated in the body 100. As shown in FIG. 15, the neck N may extend through the cap opening 108 to present the elastomeric stopper ES outside of the cap opening 108.

The cap 106 may be provided with resilient locking arms 116, each having a locking detent 118. The locking arms 116 are inwardly deflectable to allow for insertion into the side wall 104 and resilient snap engagement with locking rib(s) or locking depression(s) located on an inner surface of the side wall 104 to create a locked state between the cap 106 and the side wall 104. The locking rib(s) or the locking depression(s) may be configured, along with the locking detents 118, to restrict reverse movement of the locking detents 118 (e.g., unramped interfacing surfaces may be provided). With the locking arms 116 contained within the base 102 and the side wall 104, inward deflection of the locking arms 116 to release from the locked stated will be limited.

A compartment 114 may be located on an exterior of the body 100 formed to accommodate a product insert or other printed materials. Optionally, the compartment 114 may accommodate one or more items related to drug administration, such as a packaged antiseptic wipe, a packaged cotton ball, a bandage, and so forth.

As shown in FIGS. 16-18, the third embodiment may be modified where no cap 106 is provided. Rather, the side wall 104 is provided separate from the base 102. This arrangement allows for a larger sized elastomeric stopper ES. The side wall 104 may be provided with one or more locking ribs 120 formed to snap engage locking channel 122 formed in the base 102.

With this variation, as shown in FIG. 18, the elastomeric stopper ES of the drug vial DV may extend from the side wall 104. A covering cap 124 may be provided, formed for removable mounting relative to the side wall 104, to selectively cover the elastomeric stopper ES. The covering cap 124 may be releasably retained by interengagement of bead 126, formed on the covering cap 124, and channels 128, formed on the retaining fingers 110, particularly on rear surfaces 130 thereof.

The labeling shell 10 of FIGS. 16-18 may be assembled by first inserting the drug vial DV into the retaining fingers 110 sufficiently so as to be retainingly grasped by the retaining fingers 110. The side wall 104 may, then, be slid over the retaining fingers 110 into snap engagement with the base 102, with the covering cap 124 being mounted to fully cover the drug vial DV. Any configuration disclosed above to retain the closure 26 on the second end 18 may be utilized to secure the side wall 104 to the base 102.

The body 100 (base 102, side wall 104, the cap 106, and the covering cap 124 may be formed of polymeric material in the same manner as described above with reference to the first and second embodiments.

What is claimed is:

1. A labeling shell for a drug vial having a glass reservoir and an opening sealed by an elastomeric stopper, the reservoir having a barrel portion, the labeling shell comprising:
a polymeric tubular body formed to accommodate the reservoir of the drug vial, the tubular body having a first open end defining a first opening having a first diameter smaller than a diameter of the barrel portion of the reservoir of the drug vial so as to prevent passage therethrough of the reservoir, wherein the elastomeric stopper is exposed through the first open end with the reservoir being accommodated in the tubular body; and,
a polymeric cap mountable to the tubular body to selectively cover the elastomeric stopper of the drug vial with the reservoir being accommodated in the tubular body.

2. A labeling shell as in claim 1, wherein the tubular body includes a second open end, axially spaced from the first open end.

3. A labeling shell as in claim 2, wherein the second open end defines a second opening having a second diameter larger than a diameter of the barrel portion of the reservoir of the drug vial so as to allow passage therethrough of the reservoir.

4. A labeling shell as in claim 2 further comprising a closure formed to at least partially cover the second open end, wherein the second open end defines a second opening, the closure being formed to be received in the second opening.

5. A labeling shell as in claim 1, wherein the tubular body comprises a first tubular body portion hingedly connected to a second tubular body portion.

6. A labeling shell as in claim 5, wherein two or more cooperating locking members are provided on the first and second tubular body portions configured to lock together the first and second tubular body portions in the form of the tubular body.

7. A labeling shell as in claim 6, wherein the cooperating locking members comprise spaced-apart locking ribs that engage with a circumferential locking channel, optionally wherein the locking channel comprises a protrusion in the tubular body.

8. A labeling shell as in claim 5, wherein the tubular body is clamshell-configured.

9. A labeling shell as in claim 1, wherein the cap is connected by a tether to the tubular body.

10. A labeling shell as in claim 1, wherein at least one window is formed in the tubular body to permit viewing of the reservoir with the reservoir being accommodated in the tubular body.

11. A labeling shell as in claim 1, wherein the polymeric cap is removably mountable to the tubular body.

12. A labeling shell as in claim 1, wherein the polymeric cap is irreversibly mounted to the tubular body.

13. A labeling shell as in claim 1, wherein the tubular body comprises a polymeric material comprising polypropylene.

14. A labeling shell as in claim 13, wherein the polymeric material further comprises a thermoplastic elastomer.

15. A labeling shell for a drug vial having a glass reservoir and an opening sealed by an elastomeric stopper, the reservoir having a barrel portion, the shell comprising:
a base having a plurality of upstanding retainer fingers each having an inwardly-projecting rib, wherein the ribs collectively define a locus of points defining a first diameter smaller than the barrel portion of the reservoir, wherein a second diameter, larger than the first diameter, is defined below the ribs, between the retainer fingers, formed to accommodate the barrel portion of the reservoir, wherein, the retainer fingers are inherently biased inwardly; and,
a side wall securable to the base to circumscribe the retainer fingers.

16. A labeling shell as in claim 15 further comprising a covering cap formed to be removably mounted relative to the side wall, and wherein a bead is formed on the covering cap formed to releasably interengage one or more channels formed on the retaining fingers.

17. A labeling shell for a drug vial having a glass reservoir and an opening sealed by an elastomeric stopper, the reservoir having a barrel portion, the shell comprising:
a base having a plurality of upstanding retainer fingers, each finger having an inwardly-projecting rib at its tip, wherein the ribs collectively define a locus of points defining a first diameter smaller than the barrel portion of the reservoir, wherein each finger has an outward facing channel, wherein each channel is formed to accommodate a mounting lip of a covering cap, a tubular side wall with a first opening and a second opening, and a covering cap, wherein the base attaches to the side wall at its first opening and the side wall attaches to the covering cap at its second opening.

18. The labeling shell of claim 17, wherein the tubular side wall fits over the base whereby the upstanding retaining fingers of the base are restrained from outward movement by the side wall that is attached to the base.

19. The labeling shell of claim 17, wherein the tubular side wall comprises a plurality of inward-facing locking ribs at its first opening, wherein the locking ribs engage with a circumferential locking channel in the base.

20. The labeling shell of claim 17, wherein the upstanding retaining fingers are prevented from significant inward movement by the drug vial and are prevented from significant outward movement by the tubular side wall, and wherein the outward facing channels of the upstanding retaining fingers of the base engage with a circumferential bead on the covering cap.
